(19) United States
(12) Patent Application Publication
(10) Pub. No.: US 2023/0351167 A1
(43) Pub. Date: Nov. 2, 2023

(54) FREQUENCY MULTIPLEXED PHOTONIC NEURAL NETWORKS

(71) Applicant: ARIZONA BOARD OF REGENTS ON BEHALF OF THE UNIVERSITY OF ARIZONA, Tucson, AZ (US)

(72) Inventors: LINRAN FAN, Tucson, AZ (US); QUNTAO ZHUANG, Tucson, AZ (US)

(21) Appl. No.: 18/025,850

(22) PCT Filed: Sep. 15, 2021
(86) PCT No.: PCT/US2021/050554

§ 371 Date: Mar. 10, 2023

Related U.S. Application Data
(60) Provisional application No. 63/078,785, filed on Sep. 15, 2020.

(51) Int. Cl. G06N 3/067; G06N 3/0464; G06F 17/16

(52) U.S. Cl. CPC G06N 3/067; G06N 3/0464; G06F 17/16

(57) ABSTRACT

The present disclosure is directed to systems and methods of implementing a frequency multiplexed photonic neural network. Each input node forming an input layer receives input data that includes a plurality of multiplexed frequencies. The multiplexed frequencies are introduced to a weight matrix that includes a plurality of layers, each having a plurality of nodes that may perform the same operation at each frequency or may perform different operations at each frequency. An output layer receives, at each of a plurality of nodes, a frequency multiplexed output signal.

The present application claims the benefit of U.S. Prov. Appln. Ser. No. 63/078,785 filed Sep. 15, 2020, the teachings of which are hereby incorporated by reference in its entirety.

### TECHNICAL FIELD

The present disclosure relates to photonic neural networks, more specifically to frequency multiplexed photonic neural networks.

### BACKGROUND

The rapid development of neural networks has revolutionized numerous applications such as image recognition, natural language processing, disease diagnosis, etc. While being proposed decades ago, the real power of neural networks has not been released recently. And the recent blossoming of neural networks relies heavily on the availability of powerful computing systems. However, it was soon discovered that general purpose von-Neumann architecture is extremely inefficient in processing neural networks. There are two fundamental building blocks critical for neural networks: matrix multiplication and accumulation (MAC), and nonlinear activation. With modern microelectronics, nonlinear activation can be realized efficiently due to the high nonlinearity of electronic transistors. For example, the popular ReLu activation function for neural networks is just a comparison between input and threshold numbers, which can finish with a few clock cycles. On the other hand, MAC can be very resource- and time-consuming, as the central processing unit (CPU) in von-Neumann architecture executes programs sequentially. In most neural networks, the calculation for MAC will take the majority of computing resources and time. Therefore, a significant amount of effort has been devoted to develop non von-Neumann architectures to process large-scale MAC. Different hardware platforms, such as the graphic processing unit (GPU), tensor processing unit (TPU), and field programmable gate array (FPGA), have demonstrated significant improvement in processing speed and power consumption compared with CPU. However, as all these hardware platforms still build upon electronics, the processing power is ultimately bounded by the speed and power limits of the interconnects inside electronic circuits due to parasitic resistance and conductance. All the hardware specially designed to implement neural networks follows the idea that the calculation of columns (rows) in matrix is independent of other columns (rows), thus can be executed in parallel. For example, the core parts of TPU are the Matrix Multiply Unit and Accumulator. Instead of processing each multiplication in sequential order, 256 multiplication operations are executed in parallel in the 1st generation of TPU, leading to a peak throughput of 23 Tera-operations per second (TOPS) per chip. However, the power consumption is also significant. Each TPU core will consume tens of watts power, preventing its applications for power-restrained cases such as mobile devices, self-driving, health monitor, etc. Therefore, in addition to operation speed, one critical figure of merit is operation speed per power. Current electronics with optimized design can only achieve 0.5 TOPS/W.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A depicts an illustrative neural network topology in which a plurality of input values, such as a plurality of input tensors, each at a respective one of a plurality of different frequencies, are provided to a plurality of input nodes that form an input layer, the tensors pass through a weight matrix that includes a plurality of hidden layers, each of which may include aa different weight matrix, and a plurality of output values, each at a respective one of the plurality of frequencies are provided at each of a plurality of nodes forming an output layer, in accordance with at least one embodiment described herein;

FIG. 1B depicts an illustrative matrix multiplication and accumulation (MAC) operation using an m×n weight matrix that includes a plurality of matrix elements each representing at least one weight factor wₘₙ, a photonic application specific integrated circuit (ASIC) compute element w₁₁, and a row within the weight matrix w₂₁-w₂ₙ, in accordance with at least one embodiment described herein;

FIG. 2A is a schematic depicting frequency/wavelength multiplexing of a plurality of frequencies along a single physical link or fiber, in accordance with at least one embodiment described herein;

FIG. 2B is a schematic depicting frequency multiplexing, including a plurality of frequency multiplexed input signals, in an illustrative photonic neural network, in accordance with at least one embodiment described herein;

FIG. 3A is a block diagram that depicts the singular value decomposition of a general matrix, Wₘₙ, into an m×m unitary matrix, Uₘₘ; an m×n rectangular diagonal matrix, Σₘₙ; and an n×n unitary matrix, Vₙₙ, in accordance with at least one embodiment described herein;

FIG. 3B is a schematic diagram depicting frequency multiplexing of a plurality of input signals in a photonic neural network to provide a plurality of frequency multiplexed output signals, in accordance with at least one embodiment described herein;

FIG. 3C depicts a unit element of a photonic circuit including a Mach-Zehnder interferometer (MZI) with two phase shifters and, in accordance with at least one embodiment described herein;

FIG. 4 depicts the splitting ratio of an MZI for two adjacent DWDM channels in the case of unbalanced arms for the MZI, a first channel at 194 THz and a second channel at 194.1 THz, in accordance with at least one embodiment described herein;

FIG. 5A is a schematic that depicts balance and imbalance sections in a photonic circuit with Clements decomposition, in accordance with at least one embodiment described herein;

FIG. 5B is a schematic that depicts balance and imbalance sections in a photonic circuit with Reck-Zellinger decomposition, in accordance with at least one embodiment described herein;

FIG. 6 is a schematic diagram of an illustrative photonic network architecture for matrix size m×n in which weight matrix is mapped directly into the photonic network, in accordance with at least one embodiment described herein;

FIG. 7 depicts an element of a weight matrix implemented using an MZI modulator with a push-pull configuration, in accordance with at least one embodiment described herein;

FIG. 8 is a plot depicting estimated transmission of two architectures for photonic neural network, in accordance with at least one embodiment described herein;

FIG. 9A is a perspective view of an illustrative electro-optomechanical modulator that includes a waveguide and a mechanical structure separated by a separation distance, in accordance with at least one embodiment described herein;

FIG. 9B is a plot of the effective refractive index change as a function of separation distance between the waveguide and the mechanical structure, in accordance with at least one embodiment described herein; and

FIG. 10 is a schematic of a one convolution layer in a convolutional neural network implemented with 3-channel frequency multiplexing, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

Photonic neural networks offer a promising candidate to outperform its electronic counterparts in both speed and power consumption. MAC can be done with passive photonic circuits, and the only power consumption is light sources and detectors. Unlike electronics, photonic approach requires minimum energy for data-movement, thus the power consumption has weak dependence on total matrix size, and the figure of merit can be as high as 10 TOPS/W. For photonic neural networks, the input data is encoded into the optical field. Both coherent (phase) and incoherent (amplitude) encoding can be realized with different modulation schemes such as phase modulation, for example, Mach-Zehnder modulation, absorption modulation, etc. MAC operations can be directly realized by passing the encoded light through passive photonic circuits consisting of waveguides and beam-splitters, and thus both unitary and non-unitary photonic circuits may be used. The output light field is the MAC operation result, and can be sent to the next machine learning stage. As all signals travel at the speed of light simultaneously in photonic circuits, the outcome can be computed within tens of picoseconds. The ultimate signal processing speed will be limited by the encoding and detection of photonic signals, which can be as fast as 100 GHz with current optical modulation and photodetection technologies. With the requirement to reach higher accuracy and solve more complex problems, the size of modern neural networks is increasing exponentially. For example, ImageNet100 requires 100 layers with millions of neurons. With the rapid increase of neural network size, the teachings herein of photonic neural networks will show even larger advantage in power consumption. Both the power consumption and processing speed of photonic neural networks will be more advantageous at the inference stage as minimum reconfiguration of neural networks is required and the power budget is normally tight.

Preliminary small-scale photonic neural networks have been built based on silicon photonics and free-space spatial light modulators. Applications such as vocal processing and image recognition have been demonstrated with promising performance. In spite of promising demonstrations and great potential, significant improvement needs to be made for photonic neural networks in order to compete with electronic counterparts. As the physical footprint of photonic elements (tens of micrometers) is much larger than electronic elements (tens of nanometers), the size of photonic neural networks is limited. For free-space diffractive approaches, the maximum layer is limited to five, and further scaling-up is hindered by the dedicated alignment. For the more scalable nanophotonic approach, only a two-layer neural network with total neurons around 100 is demonstrated. The large physical size of photonic neural networks leads to low data processing capability, high fabrication requirement, and low device yields. The systems and methods disclosed herein provide photonic neural networks having the potential to: (1) achieve a processing speed of 40 Tera Operations Per Second (TOPS), which is higher or comparable to the state-of-art electronic counterpart; and (2) while improving the processing speed, further achieve a factor of 20 improvement in the processing efficiency, in terms of TOPS per watt, beyond what current state-of-the-art of electronic architectures.

The systems and methods disclosed herein take advantage of a unique feature of the light field derived from its Bosonic nature - - - frequency (wavelength) multiplexing. Indeed, light fields with different wavelengths can propagate in the same photonic circuits independently in the ideal scenario, and naively parallel computation can be realized on the same device. One challenge unique to nanophotonic machine learning (ML) chips, cross-talk between different frequencies due to nonlinear effects is inevitable and may quickly reduce or even eliminate any potential advantages gained through the use of wavelength multiplexing.

One element in the successful implementation of frequency-multiplexing in photonic neural networks is in increasing the precision of dispersion control in photonic circuits. The systems and methods disclosed herein extend the capability of ML chips (even without multiplexing), by allowing non-unitary linear transforms to be directly implemented with less gates. For applications such as parallel inference, dispersion can be minimized to ensure no additional error is caused by frequency multiplexing. For applications such as classification, dispersion may be engineered to implement different filter functions to different wavelengths.

In addition, the systems and methods disclosed herein make use of software to support the frequency-multiplexing architecture. By integrating the noise from dispersion into the training procedure of ML algorithms, the degradation in the overall performance from dispersion may be suppressed. The systems and methods disclosed herein may employ full simulated training, which may be further enhanced through the use of on-chip training by integrating the optical and electronic control.

The systems and methods disclosed herein may enable hundreds of different frequencies to be multiplexed and the potential improvement may be 2-3 orders of magnitude or greater compared to current systems. Therefore, different data sets can be encoded into different wavelengths, and processed with the same photonic neural network. The systems and methods disclosed herein beneficially permit processing data using 2-dimensional parallelism: (i) spatial domain, the same as electronic counterpart; and (ii) frequency domain, unique for optics. Considering the power consumption benefit, the frequency-multiplexed photonic neural networks disclosed herein may potentially improve the figure of merit (TOPS/W) by 4-5 orders of magnitude.

This frequency multiplexing technique is extremely advantageous for convolutional neural networks (CNN) where the same set of operations is repeatedly applied to different data at small scale. The size of the photonic circuit just needs to accommodate the small subset of the large input data, and different subsets can be encoded into different frequencies to process in parallel in the same photonic circuit. The CNN is the most successful application of machine learning, with wide applications from imaging classification to language processing. These applications are particularly applicable for both civil and defense applications. In addition to CNN, the frequency multiplexing technique may also boost the throughput of general machine learning at the inference stage, as multiple independent inputs encoded into different wavelengths can be processed simultaneously. This may greatly decrease the response time, which is more critical for real applications.

For machine learning, the majority of computing tasks is matrix multiplication and accumulation (MAC), which consist of simple number multiplication and summation. Such simple tasks typically do not require complex logic and control. The standard von-Neumann architecture, which is designed to handle general-purpose computation and complex logic, inefficiently computes MAC due to its sequential nature. In general, the equivalent size of photonic circuits is physically larger than modern electronic circuits. Thus, the ability to simply use more physical photonic resources to improve time-domain performance does not work well for photonic neural networks, and the potential performance improvement is limited. This physical size difference represents a challenge that has prevented the practical applications of photonic neural networks.

In order to overcome the limited physical size of photonic circuits, other degrees of freedom to improve data processing capability of photonic neural networks are needed. Potential candidates include polarization, transverse modes, and frequency. It is challenging to realize multiplexing with polarization and transverse modes due to the highly dispersive behavior induced by subwavelength confinement and asymmetric structures. Moreover, due to the limited dimensions of polarization and spatial modes, the potential improvement is also very limited (polarization 2×, spatial mode 2×-4×). The frequency degree of freedom is ideal to realize parallel data processing with photonic circuits. Due to the Bosonic nature of photons, different frequencies can propagate in the same photonic circuit with minimal or even no cross-talk in the case of negligible optical nonlinearity. Beneficially, the frequency degree of freedom has infinite dimensions, allowing large-scale multiplexing. The major challenge is the control of frequency dispersion, to ensure that different frequencies behave the same way in terms of matrix multiplication. Such dispersion control may be accomplished by careful design of waveguide dimensions, photonic materials, and specific microarchitectures specialized for matrix multiplication.

Accordingly, the present disclosure provides a frequency multiplexed neural network that includes advantages described herein. The neural network may include: an input layer that includes a plurality of input nodes, each of the plurality of input nodes to receive a respective one of a plurality of input values, each of the plurality of input values provided at a respective one of a plurality of different frequencies; a plurality of hidden layers to provide a weight matrix operably coupled to the input layer, each of the plurality of hidden layer having at least one weight factor associated therewith; and an output layer that includes a plurality of output nodes operably coupled to at least one of the plurality of hidden layers, each of the plurality of output nodes to provide a respective one of a plurality of output values, each of the plurality of output values at a respective one of the plurality of frequencies.

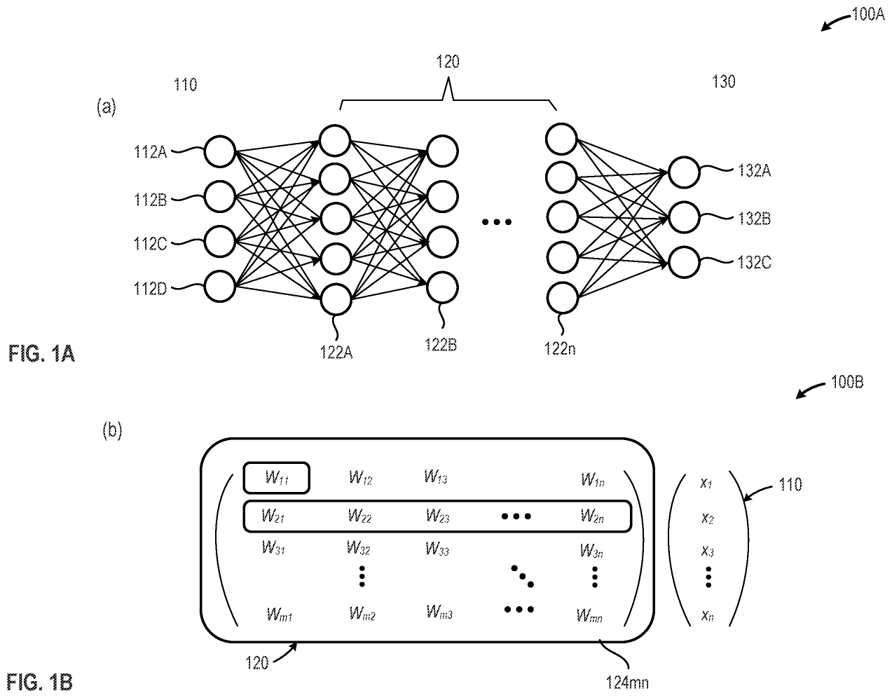

FIG. 1A depicts an illustrative neural network topology 100 in which a plurality of input values, such as a plurality of input tensors, each at a respective one of a plurality of different frequencies, are provided to a plurality of input nodes 112A-112n that form an input layer 110, the tensors pass through a weight matrix 120 that includes a plurality of hidden layers 122A-122n, and a plurality of output values, each at a respective one of the plurality of frequencies are provided at each of a plurality of nodes 132A-132n forming an output layer 130, in accordance with at least one embodiment described herein. FIG. 1B depicts an illustrative matrix multiplication and accumulation (MAC) operation 140 using an m×n weight matrix 120 that includes a plurality of matrix elements 124ii-124ₘₙ each representing at least one weight factor wₘₙ, a photonic application specific integrated circuit (ASIC) compute element wₘₙ, and a row within the weight matrix 120, w₂₁-w₂ₙ, in accordance with at least one embodiment described herein. The systems and methods disclosed herein employ photonic circuits that, in embodiments, beneficially compute the entire weight matrix at once as compared to electronic ASICs which compute the weight matrix one row/column at a time or a CPU which computes only one element at a time.

As depicted in FIGS. 1A and 1B, the use of frequency multiplexing to enhance the processing capability of photonic neural networks 100. Using frequency multiplexing, different frequency channels pass through the same photonic circuit 100 independently. Therefore, by encoding different dataset values into respective ones of a plurality of different carrier frequency channels, a large number of data can be processed in parallel without increasing the size and power of photonic circuits. In such frequency-enhanced photonic neural networks 100, two parallel-acceleration mechanisms to processes MACs are utilized simultaneously: (i) different matrix elements in a single dataset are calculated in parallel enabled by photonic circuits, and (ii) different datasets can be calculated independently enabled by frequency enhancement. Compared with traditional electronics, this two-layer parallelism can lead to great improvement in speed and power consumption. Also, the utilization of frequency multiplexing can mitigate the large foot-print and low device density of photonic neural networks compared with electronics.

Historically, signal transmission in fiber can be treated as a special case of photonic computing in general photonic circuits. Instead of matrix multiplication and accumulation, data x encoded in optical fields in fiber may be multiplied by a complex scalar with unity amplitude e^{iϕ} if loss is neglected. With frequency multiplexing, the phase factor ϕ is frequency-dependent on ϕ(ω). For such scalar operation, direct detection of each frequency channel will eliminate the influence of frequency dispersion given as |xe^{iϕ}|=x². Even for coherent detection where the phase is important, a proper dispersion compensation step at the end of the fiber link can eliminate the frequency-dependent phase ϕ(ω) by multiplying the signal with a constant e^{-iϕ}(ω). This is routinely done in fiber communications by using dispersion compensation elements such as fiber Bragg grating and dispersion compensation fiber.

In contrast, in a photonic neural network 100, matrix multiplication is required instead of scalar operation:

yⱼ=Σᵢwⱼᵢxᵢ (1)

Due to the coherent nature of light fields, weight matrix wⱼᵢ is normally realized with interference among different paths. The optical phase accumulated in each optical path depends both on the path L and the optical frequency ω:

φ=nLω/c (2)

As a result, the weight matrix is highly frequency dependent:

wⱼᵢ=Wⱼᵢ(ω) (3)

This may cause problems for frequency multiplexing of photonic neural networks 100, as the deviation from the desired weight matrix 120 may lead to a higher error rate for the neural network 100.

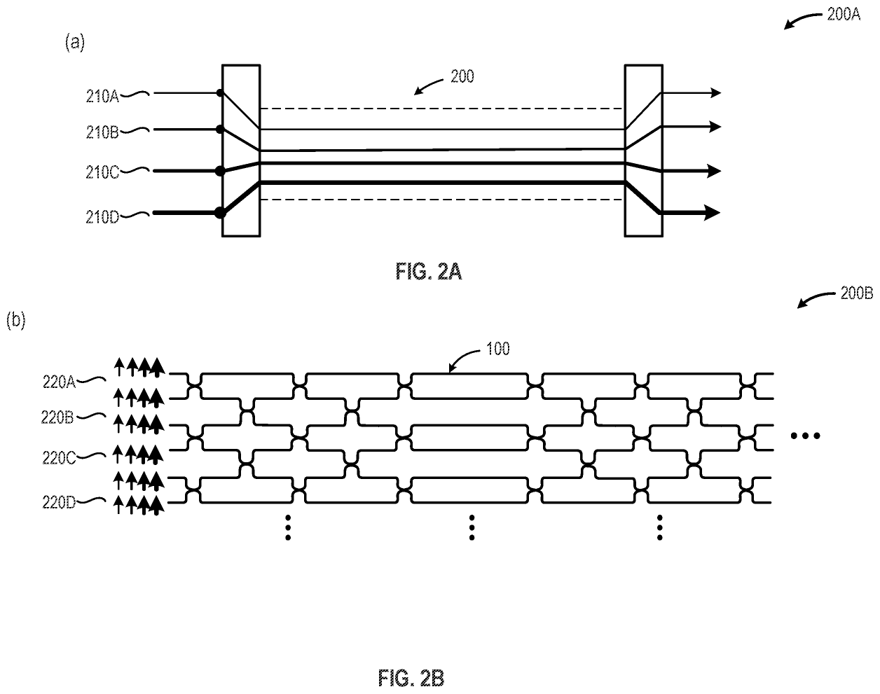

FIG. 2A is a schematic 200A depicting frequency/wavelength multiplexing of a plurality of frequencies 210A-210n along a single physical link 220 or fiber, in accordance with at least one embodiment described herein. FIG. 2B is a schematic 200B depicting frequency multiplexing, including a plurality of frequency multiplexed input signals 220A-220F, in an illustrative photonic neural network 100, in accordance with at least one embodiment described herein. As depicted in FIG. 2B, the interference among different optical pathways and the phase frequency dependency present challenges in frequency multiplexing.

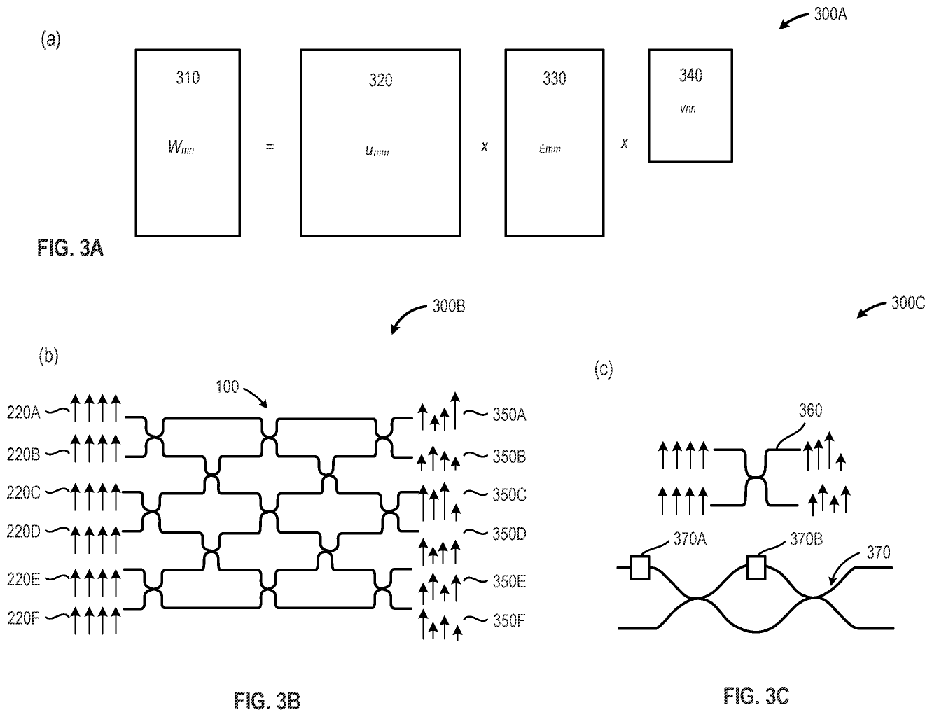

FIG. 3A is a block diagram 300 that depicts the singular value decomposition of a general matrix, Wₘₙ, 310 into an m×m unitary matrix, Uₘₙ, 320; an m×n rectangular diagonal matrix, Σₘₙ, 330; and an n×n unitary matrix, Vₙₙ, 340, in accordance with at least one embodiment described herein. FIG. 3B is a schematic diagram 300B depicting frequency multiplexing of a plurality of input signals 220A-220F in a photonic neural network 100 to provide a plurality of frequency multiplexed output signals 350A-350F, in accordance with at least one embodiment described herein. FIG. 3C depicts a unit element 360 of a photonic circuit including a Mach-Zehnder interferometer 370 with two phase shifters 372A and 372B, in accordance with at least one embodiment described herein.

Based on singular value decomposition, any matrix with size m×n can be decomposed into the product of three matrices:

UΣV (4)
where U is an m×m unitary matrix;
   Σ is m×n rectangular diagonal matrix; and
   V is n×n unitary matrix.

With reference to FIG. 3C, the decomposition of unitary matrices U and V into photonic beam splitters and phase shifters is well known, based on the Reck-Zeilinger or Clements method. These phase shifters and beam splitters can be grouped into Mach Zehnder interferometers (MZIs). The rectangular diagonal matrix Σ can be realized with a series of independent MZIs. Therefore, the whole weight matrix can be decomposed into MZIs. The relation between the output and input of the MZI can be expressed as:

αₒᵤₜ₁=e^{i(ϕ+θ)}(αᵢₙ₁ cos(Θ+θ)+αᵢₙ₂ sin(Θ+θ)) (5)

αₒᵤₜ₂=e^{i(θ)}(αᵢₙ₂ sin(Θ+θ)−αᵢₙ₂ cos(Θ+θ)) (6)
where: ϕ and θ are implemented with two phase shifters controlling phase and amplitude, respectively; and
   θ is the static imbalance between the two MZI arms due due to optical path length difference.

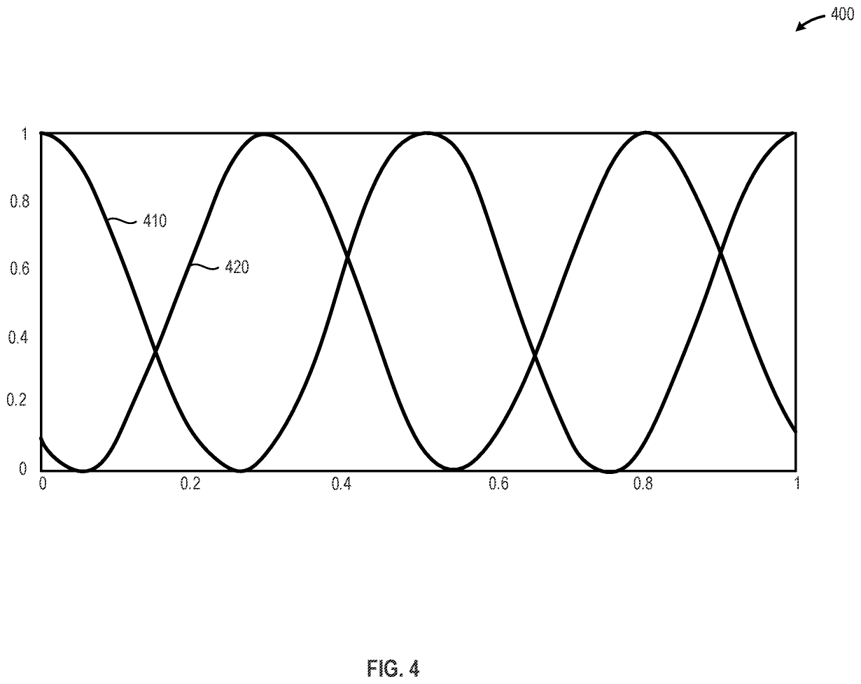

FIG. 4 depicts the splitting ratio of an MZI for two adjacent DWDM channels, a first channel 410 at 194 THz and a second channel 420 at 194.1 THz, in accordance with at least one embodiment described herein. For certain values of static imbalance e at two different frequencies, the influence of phase error may be determined as:

δθ=δnL(ω₁−ω₂)/c (7)

As depicted in FIG. 4, typical values for silicon photonics, n=3 and length imbalance of 200 μm, have been used to plot the MZI power splitting ratio for two adjacent DWDM frequency channels (194 THz and 194.1 THz). Clearly, the discrepancy between the two frequency channels can be as large as 80% for certain phases. If phase term is taken into account, the equivalent discrepancy will be even larger. For a m×m unitary matrix, the photonic circuit has ˜m2 beam splitters and circuit depth of 2 m or 4 m depending on Clements or Reck-Zeilinger decomposition. This leads to an overall ˜(m²+n²) beam splitters count for the entire circuit and ˜(m²+n²) phase shifters. Given that a single beam splitter has exhibited frequency dispersion the final weight matrices for different frequencies will be almost completely unrelated. Therefore, a special design of photonic circuits may be carried out to implement frequency multiplexing for photonic neural networks.

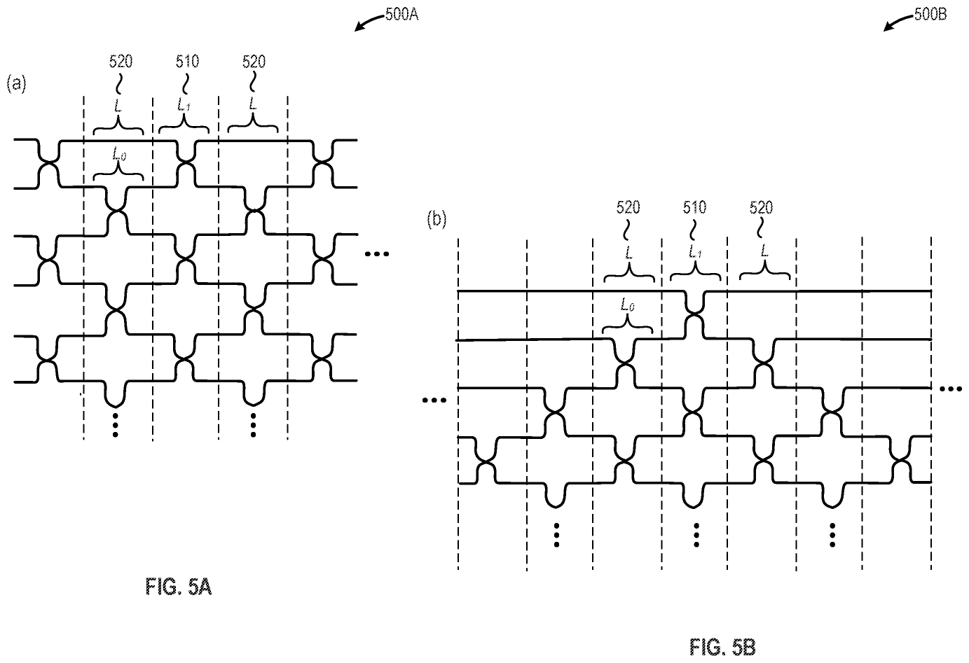

FIG. 5A is a schematic 500A that depicts balance 510 and imbalance 520 sections in a photonic circuit with Clements decomposition, in accordance with at least one embodiment described herein. FIG. 5B is a schematic 500B that depicts balance 510 and imbalance 520 sections in a photonic circuit with Reck-Zellinger decomposition, in accordance with at least one embodiment described herein.

In order to minimize or even eliminate the influence of frequency dispersion, all possible paths through the weight matrix 100 should have the same optical path length (ideally same physical length and same effective refractive index). Therefore, the unitary operation for different frequencies is only different by a global phase. This may be readily achieved for all paths except the first and last ones in Clements decomposition. Referring to FIG. 5A, with Clements decomposition, the photonic circuits can be divided into sections. In each section, each optical path will go through one beam splitter, except the first and last one, which only go through one beam splitter every other section. If identical balanced MZIs are used for beam splitters, the optical paths (L₀) paths will be the same for all paths except the first and last ones. For sections that the first and last paths do not go through beam splitters, the corresponding optical path L must be made the same as L₀ to ensure no imbalance presents in the circuits. In total, there will be ˜n sections that need to be matched.

Referring to FIG. 5B, for Reck-Zeilinger decomposition, all optical paths have sections that only contain delay lines. As a result, there are ˜n²/2 sections that need to be matched to sections with beam splitters. Due to the 2π periodicity of optical phases, the response of the photonic circuit will remain the same for certain discrete frequency values with imbalance circuit (L≠L₀). In this case we should only select frequencies:

f=N·c/|L−L₀| (8)
where: N is an integer

The smaller the difference between L0 and L will lead to a greater number of frequency channels.

If all optical paths are matched and the phases for each balanced MZI are tune to 0 (θ=ϕ=0) as depicted in FIG. 3C, the whole photonic circuit will simply perform identity operation. This provides us a convenient approach to characterize the fabricated device. In practical applications, the optical path length is difficult to control precisely. In this case, we can fine tune the phase shifters to compensate for the fabrication error to make all paths balanced. Such a balanced design will make sure that all frequencies experience the same baseline of the identity matrix in this phase-shifter set-up. To this end, we will develop a protocol for the fine-tuning of the phase-shifters, when one only has access to the control of the input coherent state power and phases, and the measurement results of the power of the output ports. To accomplish this goal, we will rely on systematic optimization tools and machine learning algorithms to train the phase shifters for the minimum errors. The cost function will be one-norm deviation to the ideal output from an identity matrix plus a regularization on the amount of phase tuning, to make sure that the phase shifters do not generate multiples of 2 t phase difference, which will be adding to the dispersion error when different frequencies go through the same device.

While different tuning mechanisms can be used for the phase shifter (detailed in Sec. 2.3), the result is the change of effective refractive index 6n. Under tuning, the photonic circuit will inevitably become imbalanced, thus different frequency channels experience different matrix operations. For a single phase shifter, the relative phase error given by:

δϕ/ϕ=δω/ω (9)

Can be kept as low as −5×10⁻⁴ for two adjacent DWDM channels. However, phase error will accumulate with the increase of circuit depth. For a 256×256 matrix size commonly used for electronic ASICs, the phase error may be as large as 13% for two adjacent DWDM channels. In order to mitigate this frequency dispersion, smaller distance between different frequency channels, such as 5 GHz may be used.

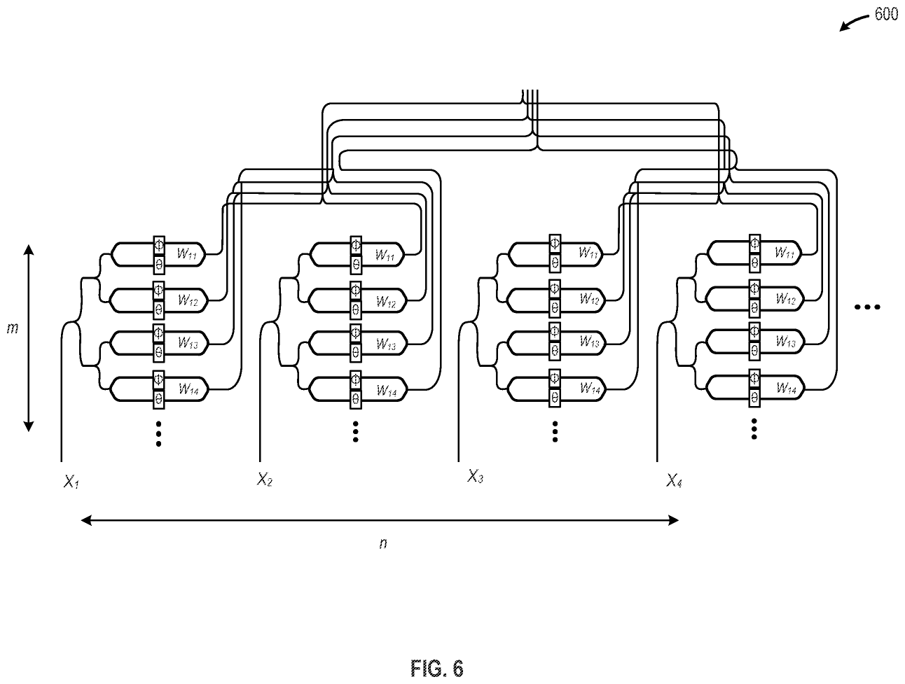

FIG. 6 is a schematic diagram of an illustrative photonic network architecture 600 in which weight matrix is mapped directly into the photonic network 600, in accordance with at least one embodiment described herein. As depicted in FIG. 6, the network 600 circuit length and width scale with m and n respectively and the effective circuit depth is 1. FIG. 3 (above) depicts a photonic neural networks based on singular value decomposition of general matrices into unitary matrices and square diagonal matrices. The implementation of frequency multiplexing in this architecture requires matching of optical path lengths. This adds complexity to practical applications. Furthermore, the architecture depicted in FIG. 3 may be less efficient in matrix processing, as one general weight matrix is decomposed into three matrices 320, 330, 340, which triples the processing resource (number of components or processing time). Most importantly, the phase error due to frequency dispersion will accumulate with the increase of matrix size, making it challenging to implement frequency multiplexing. Therefore, we propose a completely different architecture for photonic neural networks. The architecture depicted in FIG. 6 does not rely on singular value decomposition. Instead, direct mapping of general weight matrices onto photonic circuits is used. More importantly, influence of frequency dispersion can be minimized.

This architecture consists of three parts for matrix operation, including input data fan-out, multiplication of individual elements in matrices, and accumulation as depicted in FIG. 5. For a general m×n weight matrix with n data, each data input xⱼ may be split equally into m paths. This can by done with either 1-to-m multimode interferometers, an array of Y-junction, an array of directional coupler, etc. Each path then goes through an amplitude modulator, and the transmission is proportional to one weight element wᵢⱼ. The output of the amplitude modulators wᵢⱼxⱼ. By regrouping the output from m×n amplitude modulators, the accumulation operation may be performed by combining the corresponding paths with the same index i to provide the matrix output:

yᵢ=Σwᵢⱼ·xⱼ (10)

The amplitude modulators can be realized with MZIs, electro-absorption effect, etc. Similar to the fan-out step, the accumulation step can also be realized with either m m-to-1 multimode interferometers, an array of Y-junction, an array of directional coupler, etc. In the accumulation step, the output from different paths should be added constructively. The phase difference between different paths should be 0 or 2Nπ. One straightforward method is to use an array of Y-junctions or 2-to-1 multimode interferometers to combine different paths in a symmetric binary tree structure (FIG. 5). Due to the direct 1-to-1 mapping between weight matrix and amplitude modulators, arbitrary matrices can be realized without any extra matrix processing (such as singular value decomposition).

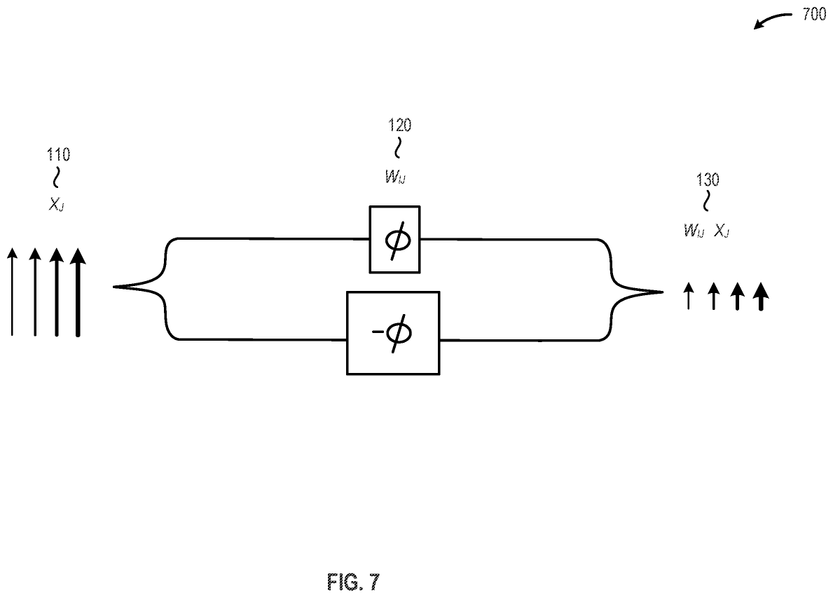

FIG. 7 depicts an element 700 of a weight matrix implemented using an MZI modulator with a push-pull configuration, in accordance with at least one embodiment described herein. As depicted in FIG. 7, the weight matrix element may provide a uniform response at different frequencies.

In order to implement frequency multiplexing, different data sets encoded with different frequencies will enter the same fan-out, matrix multiplication, and accumulation steps. In the matrix multiplication step, a balanced MZI with push-pull configuration may be used, as depicted in FIG. 7. The output amplitude of the balanced MZI is given by:

xⱼ cos(ϕ)e^{jϕ} (11)

The weight element is given by:

wᵢⱼ=cos(ϕ) (12)

The constant phase term e^{jϕ} can be neglected, as long as it is kept the same for all paths and does not influence the constructive combination of different paths. Experimentally, there will be small phase differences between different paths due to fabrication imperfections. This can be calibrated by having the same input for all ports and maximizing the output amplitude by adding a static phase shift a to each amplitude modulator. With the push-pull configuration, this means the phases on the two paths are changed from ϕ and −ϕ to ϕ+σ and −ϕ+σ.

The phase error induced by frequency difference is given by:

δϕ/ϕ=δω/ω˜10⁻⁴ (13)
for two adjacent DWDM channels, and uniform amplitude response can be expected. This phase error will not accumulate with the increase of matrix size, as the depth of photonic circuits in this architecture is always 1. This advantage is beneficial for the scaling-up of photonic circuits to implement large-scale neural networks.

As discussed above, this new architecture features the advantages of robustness under frequency multiplexing and direct correspondence between photonic circuit and weight matrix. Here we discuss the total number of devices required for this architecture. We assume that the data fan-out and accumulation steps are both realized with Y-junctions. As the fan-out and accumulation are reversed processes, they each require n(m−1) Y-junctions. In addition, 2 nm Y-junctions are required for the amplitude modulator. Therefore, this architecture requires ˜4 nm Y-junctions for a general m×n weight matrix. Compared with the approach based on singular value decomposition which required ˜(n²+m²) 2-by-2 beam splitters. The scaling of physical resource for this new architecture is factor of 2 worse than the singular value decomposition approach, assuming commonly used case n=m. However, considering that Y-junction has much smaller foot-print than 2-by-2 beam splitters, the physical size of the passive components in two architectures may be similar. With the use of 1-by-d multi-channel multimode interferometer, the device count for the fan-out and accumulation steps may be further reduced. The size of the phase shifters that may be used for this architecture is 2 nm. However, the push-pull configuration requires that half of the phase shifters have opposite phases with the other half as depicted in FIG. 6. For certain modulation methods, such as electro-optic and mechanical modulation, such one pair of phase shifters can be realized with one device, and only one electronic control is required. Effectively, this architecture only needs ˜nm modulators. This scaling is better than the architecture based on singular value decomposition. As modulators are much larger than Y-junctions and 2-by-2 beam splitters, they will occupy most areas of photonic circuits. As a result, this new architecture may have a much smaller overall size.

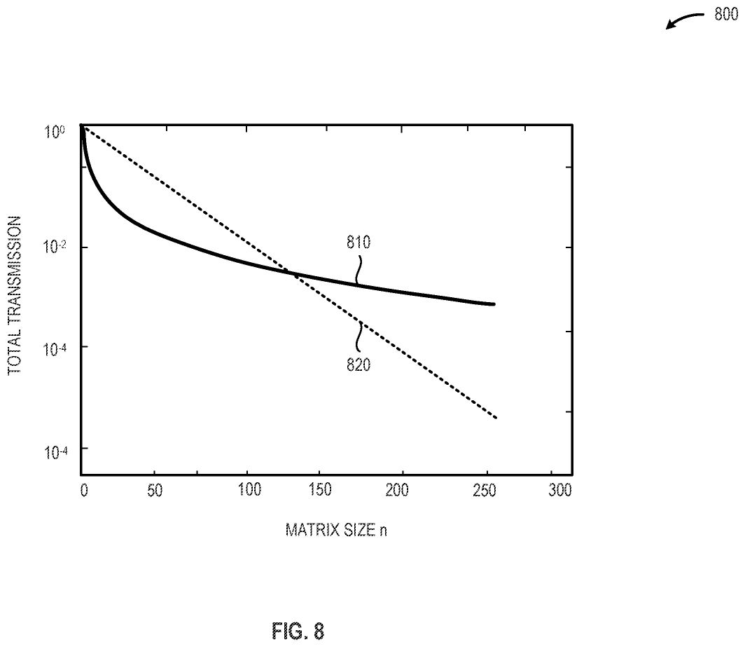

FIG. 8 is a plot 800 depicting estimated transmission of two architectures for photonic neural network 100, in accordance with at least one embodiment described herein. In addition, this new architecture also features low optical loss. As the depth of fan-out and accumulation steps is only log₂ n and the depth of accumulation step is a constant 1, the transmission is given by:

T₁˜η₁^{2(1+log}^{₂}ⁿ⁾ (14)
where: η₁ is the transmission of a single Y-junction

Note that in the accumulation step, there is also loss due to the fact that only one mode is kept in each Y-junction, leading to an average transmission:

T₂˜1/n (15)

Another loss source is the waveguide crossing in the accumulation step. In the current layout depicted in FIG. 5, each path will go through ˜η log₂ n/2, leading to transmission:

T₃˜η2^{n log}^{₂}^{n/2} (16)

This crossing number can potentially be decreased to (log₂ n)² with optimized device layout. The total transmission 810 is plotted in FIG. 8 and is given by:

T₁T₂T₃ (17)

As a reference, FIG. 8 also includes a plot 820 of the transmission for conventional architecture based on singular value decomposition, whose transmission is ˜Tᵣ=ηᵣⁿ with ηᵣ the transmission of a 2-by-2 MMI. In the plot, we use standard performance from silicon photonics foundry: Y-junction (or 1-by-2 MMI) loss 0.1 dB loss, waveguide crossing 0.01 dB loss, and 2-by-2 MMI 0.2 dB. With small matrix size n, the new architecture has higher loss, due to the 1/n transmission limited by the accumulation step. When the matrix size is above ˜128, the loss is dominated by the neural network depth. With smaller unit device loss, the new architecture shows significant advantage.

While photonic neural networks can finish the multiplication and accumulation of one matrix with the speed of light, the overall system performance will also be determined by the speed of data encoding, weight matrix update, and light detection. While high-performance integrated photodetectors with small size, high efficiency, and large bandwidth (well beyond 10 GHz) are widely available on silicon photonics, it is expected that the photodetector will not be the limiting factor for the system performance. On the other hand, data encoding and weight matrix update requires the modulation of light, which is challenging to realize low loss, small size, and low power at the same time. Several modulation techniques including thermal tuning, current injection, electro-optic modulation, and electro-optomechanical modulation may be useful. Especially, it is anticipated that data encoding and weight matrix update will have different requirements on optical modulation. For example, data encoding will emphasize more on the modulation bandwidth in order to maximize the overall system speed. Device size and insertion loss are less critical, as they only introduce a constant factor for each channel. For weight matrix update, large modulation bandwidth is also preferred, but more emphasis will be placed on device size and insertion loss, which scales quadratically with matrix size. Moreover, the frequency of weight matrix update is much less than data encoding. For certain neural networks (such as recurrent neural networks), there is even no need to update the weight matrix. Therefore, the smaller modulation bandwidth of weight matrix update will have minimal effect on overall system speed.

Thermo-optic tuning is the most widely used method to reconfigure photonic circuits. By putting high resistive metal strips on top of photonic waveguides, the device temperature can be controlled by injecting current through metal strips. With extensive optimization from silicon photonics foundries, thermo-optic phase shifters can achieve low insertion loss ˜0.3 dB and small device length ˜100 μm. However, the maximum modulation bandwidth is limited to ˜100 kHz due to the slow thermal dissipation process. Another major drawback is that thermo-optic phase shifters consume large static power to maintain the phase shift. While the power consumption has dropped to ˜20 mW for t phase shift, the total power consumption is still significant considering the large matrix size. For 64-by-64 matrices, the average power for thermal tuning alone is close to 50 W. While such high power is not practical for large-scale demonstration, thermo-optic tuning will be convenient to verify system performance at small scales due to its easy fabrication and robustness.

Another possibility to tune the weight matrix 120 is electro-optic modulation. Due to the centro-symmetric nature of silicon crystal, there is no intrinsic electro-optic effect for silicon photonics. By using a biased PN junction across the waveguide, the carrier density in the waveguide can be changed by applying different voltages across the PN junction, leading to the change of refractive index. Bandwidth above 25 GHz has become standard for silicon photonics foundries. However, the device length is still large (˜1 mm), and the insertion loss is high (˜3 dB) due to free carrier absorption. Therefore, it will be difficult to use electro-optic modulation for weight matrix update, as both the total device size and loss will scale quadratically with the matrix size. On the other hand, electro-optic modulation is ideal for data encoding, which requires large bandwidth to reach high operation speed. The overall system size and loss will only increase slightly.

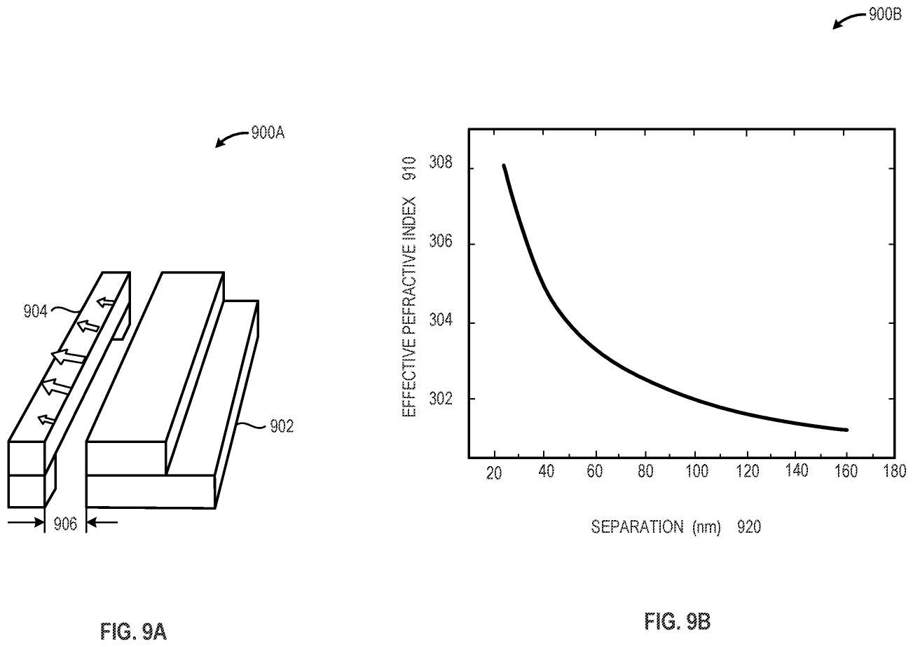

FIG. 9A is a perspective view of an illustrative electro-optomechanical modulator 900 that includes a waveguide 902 and a mechanical structure 904 separated by a separation distance 906, in accordance with at least one embodiment described herein. FIG. 9B is a plot 900B of the effective refractive index change 910 as a function of separation distance 920 between the waveguide 902 and the mechanical structure 904, in accordance with at least one embodiment described herein. As discussed above, neither thermo-optic tuning nor electro-optic modulation will be practical for weight matrix update at large-scale. In embodiments, electro-optomechanical modulation may be used to update the weight matrix 120. As depicted in FIG. 9A, photonic waveguides 902 carrying optical data will be evanescently coupled with another mechanical structure 904. Electro-static force will be used to actuate the mechanical structure 904, which will modulate the effective refractive index of the optical mode. As depicted in FIG. 9B, in embodiments, the change of effective refractive index 910 can be as large as 0.02 with only 30 nm flexural displacement. Such large change of effective refractive index means that only ˜50 μm long device will be sufficient to realize 2π phase shift and arbitrary value of weight matrix element. By minimizing the waveguide dimension and effective mass, such displacement can be possibly realized with only ˜3V voltage, comparable to the voltage used in analog electronics. The bandwidth of electro-optomechanical modulation is limited by the first resonant frequency of the mechanical motion. By using short device length (<50 μm), the resonant frequency of the first order flexural mode can be pushed above 100 MHz for silicon. Such modulation bandwidth is close to electronic ASIC for machine learning. As only static voltage is required, electro-optomechanical modulation will not consume static power. Combining the high modulation efficiency, large bandwidth, and low loss, electro-optomechanical modulation will be the ideal solution to weight matrix update for photonic neural networks.

The performance goal achievable by the photonic MAC calculator as described herein utilizing frequency multiplexing. An important measurement tool is the floating point operations per second (FLOPS), measured in TOPS. At the same time, energy efficiency is a related measurement tool, as the energy consumption eventually leads to heat and increased temperature will limit the device performance. The total power of such heating is measured by the thermal design power (TDP) in watts and then energy efficiency is measured in rate of calculations per unit power in units of TOPS/watt.

The state-of-the-art photonic MAC calculator has around 4TOPS performance in FLOPS, with around 3w TDP. While the FLOPS has just started to match the early generation of TPUs, the energy efficiency of 1 TOPS/watt is already a factor of 2 lower than the state-of-the-art electronic device. The photonic MAC calculator described herein enjoys a great advantage from frequency multiplexing. Assuming F frequency being multiplexed, the expected FLOPS will obtain a factor of F improvement. Moreover, unlike electronics, photonic approach requires minimum energy for data-movement, thus the power consumption has weak dependence on total matrix size, which means that the TDP will remain unchanged; This means a factor of F improvement in TOPS/watt.

The reliance on frequency encoding requires be multiple frequency modes involved in the optical neural network design. The systems and methods of precisely controlling the different dispersive phase shifts on different frequencies as described herein will reduce the errors, however inevitably the residue noise still affects the overall performance. To understand and control the errors, a novel theory on the error mitigation and noisy training of photonic neural networks may be employed.

The coherent approach has depth scaling linearly in the matrix size, and therefore an overall phase error increasing linearly in the input dimension is expected; the direct-mapping approach has a shallow logarithmic depth, moreover only a single-layer needs to be tuned, therefore the phase error will be much smaller than the coherent approach. We will analyze both cases in detail. With the same approach, other imperfections such as engineering fluctuations can also be taken into consideration. However, since the neural network device is in a controlled environment, we assume that the imperfections are not time-dependent.

In the Heisenberg picture, a MAC in the coherent matrix approach is described by a matrix which encodes the mode transforms. Denote the annihilation operators of each mode as α_{f,s} where f is the frequency index and s is the spatial index, the transform on a MAC is described by a unitary matrix Uₛ, which applies the transform:

α_{f,s}′=Σ_{P}(Uₛ)ₛₚα_{f,p} (18)

Suppose the transform U* is implemented among all frequency modes, in general dispersion leads to a frequency dependent transform:

U*+ΔUₛ(U*) (19)

Note that the fluctuation term ΔUₛ(U*) might in general also depend on the target transform U*. Examples of the ΔUₛ(U*) can be a different phase shift linear in different frequencies, or more complicated functional dependence. Consider the direct-mapping approach, as the analyses will be much easier, as a single layer of the phase shifters will be tuned and phase errors simply lead to constant shifts in each element of the matrix.

Photonic neural networks enhanced by frequency multiplexing will be extremely suitable to realize convolutional neural networks (CNN) which is one of the most successful and widely used methods in image and video recognition, recommender systems, image classification, medical image analysis, and natural language processing.

In embodiments, the whole image is divided into small images (with padding), and each small image is filtered by the same Kernel matrix. With photonic neural networks, the kernel matrix is implemented with photonic circuits consisting of beamsplitters and phase shifters as depicted in FIG. 1B. By encoding different small images with different frequencies, the whole convolution layer can be processed simultaneously. As the size of the kernel matrix is small (usually 2×2 or 3×3), a small photonic circuit can be used to process a large image given there are enough frequency channels.

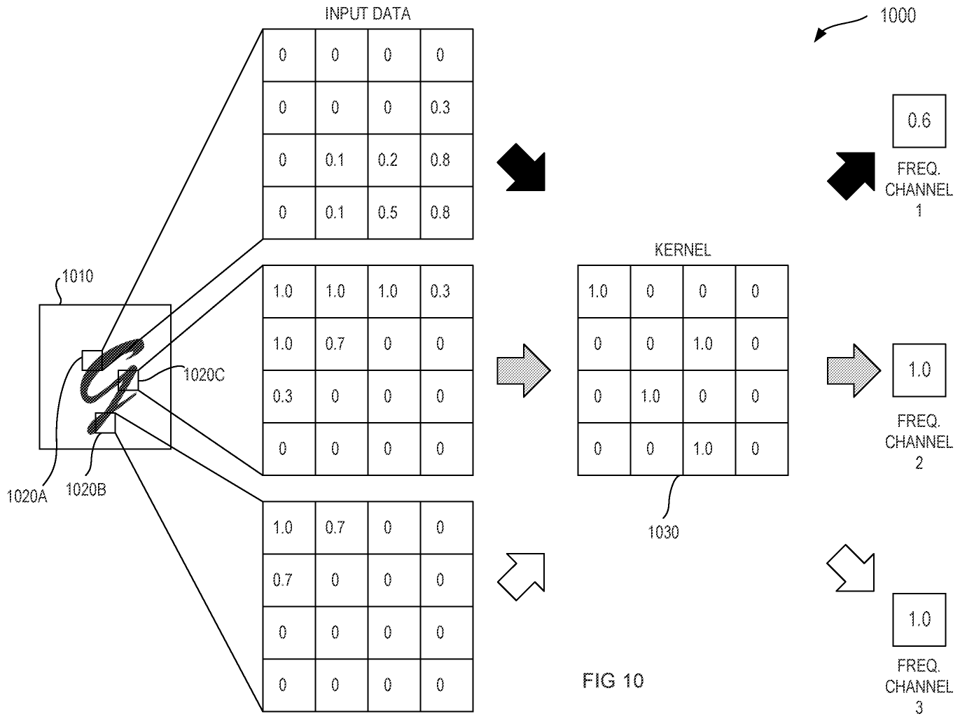

FIG. 10 is a schematic 1000 of a one convolution layer in a convolutional neural network implemented with 3-channel frequency multiplexing, in accordance with at least one embodiment described herein. The network 1000 depicted in FIG. 10 may be useful in implementing convolutional neural networks widely applicable to image and video recognition, recommendation systems, medical image analysis, and natural language processing. FIG. 10 depicts such an example convolution layer to process the handwriting digit 1010 from MNIST database is shown in FIG. 10. The whole image is divided into small blocks 1020A-1020n (three depicted in FIG. 10, 1020A, 1020B, and 1020C), and different small blocks are processed repeatedly by the same Kernel matrix 1030. By encoding different small blocks into different frequencies, the whole convolution layer can be processed simultaneously (i.e., the same network requires only one processing step that simultaneously includes all three frequencies rather than three sequential processing steps). As the size of the kernel matrix 1030 is small (usually 2×2 to 4×4), a small photonic circuit can be sufficient to process a large image given there are enough frequency channels.

Photonic devices will implement parallel inference with different frequency channels. Each frequency channel may represent one data set from one user. In this way, one photonic neural network can serve multiple users at the same time, greatly decreasing the response time, which is critical for applications such as image and object detection and identification for autonomous driving applications. The speed and efficiency improvement will also be compared with single-frequency photonic neural networks and conventional electronic ASIC. The photonic neural networks disclosed herein may be used to implement different algorithms such as: multi-layer perceptrons, recurrent neural networks, and convolutional neural networks.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Thus, the present disclosure is directed to systems and methods of implementing a frequency multiplexed photonic neural network. Each input node forming an input layer receives input data that includes a plurality of multiplexed frequencies. The multiplexed frequencies are introduced to a weight matrix that includes a plurality of layers, each having a plurality of nodes that may perform the same operation at each frequency or may perform different operations at each frequency. An output layer receives, at each of a plurality of nodes, a frequency multiplexed output signal.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for providing a frequency multiplexed photonic neural network.

According to example 1, there is provided a frequency multiplexed neural network. The neural network may include: an input layer that includes a plurality of input nodes, each of the plurality of input nodes to receive a respective one of a plurality of input values, each of the plurality of input values provided at a respective one of a plurality of different frequencies; a plurality of hidden layers to provide a weight matrix operably coupled to the input layer, each of the plurality of hidden layer having at least one weight factor associated therewith; and an output layer that includes a plurality of output nodes operably coupled to at least one of the plurality of hidden layers, each of the plurality of output nodes to provide a respective one of a plurality of output values, each of the plurality of output values at a respective one of the plurality of frequencies.

Example 2 may include elements of example 1 where each of the hidden layers includes a plurality of nodes, each of the nodes having the same weight factor for each of the plurality of frequencies.

Example 3 may include elements of any of examples 1 or 2 where each of the hidden layers includes a plurality of nodes, each of the nodes having a different weight factor for each of at least two of the plurality of frequencies.

Example 4 may include elements of any of examples 1 through 3 where each of the hidden layers performs at least one matrix multiplication and accumulation operation.

Example 5 may include elements of any of examples 1 through 4 where the plurality hidden layers comprise at least one weight factor matrices.

Example 6 may include elements of any of examples 1 through 5 where the plurality of weight factor matrices comprises a plurality of weight factor matrices generated by decomposition of an m×n weight factor matrix.

Example 7 may include elements of any of examples 1 through 6 where decomposition of an m×n weight factor matrix comprises decomposing the m×n weight factor matrix into a product of three matrices UΣV, where: U includes an m×m unitary matrix; includes an m×n rectangular diagonal matrix; and V includes an n×n unitary matrix.

Example 8 may include elements of any of examples 1 through 7 where the decomposition of the m×m unitary matrix U and the n×n unitary matrix V comprises decomposition of the U and V matrices into a plurality of photonic beam splitters and a plurality of phase shifters using at least one of the Reck-Zeilinger method or the Clements method.

Example 9 may include elements of any of examples 1 through 8 where one or more of the plurality of photonic beam splitters and one or more of the plurality of phase shifters are grouped into Mach Zehnder Interferometers (MZIs).

Example 10 may include elements of any of examples 1 through 9 where each of the plurality of frequencies includes matched optical path lengths through the plurality of hidden layers.

Example 11 may include elements of any of examples 1 through 10 where plurality of hidden layers comprise an m×n weight matrix.

Example 12 may include elements of any of examples 1 through 11, and the neural network may further include: one or more splitter elements to split each of a plurality of input signals equally into m paths upstream of the m×n weight matrix.

Example 13 may include elements of any of examples 1 through 12 where the one or more splitter elements comprise at least one of: one or more 1-to-m multimode interferometers; one or more Y-junction arrays; or one or more directional couplers.

Example 14 may include elements of any of examples 1 through 13 and the neural network may further include: one or more accumulator elements to combine each of a plurality of output signals downstream of the m×n weight matrix.

Example 15 may include elements of any of examples 1 through 14 where the one or more accumulator elements comprise at least one of: one or more m-to-1 multimode interferometers; one or more Y-junction arrays; or one or more directional couplers.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects; and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or an “embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. A frequency multiplexed neural network, comprising:
an input layer that includes a plurality of input nodes, each of the plurality of input nodes to receive a plurality of input values, each of the plurality of input values provided at a respective one of a plurality of different frequencies;
a plurality of hidden layers to provide a weight matrix operably coupled to the input layer, each of the plurality of hidden layers having at least one weight factor associated therewith; and
an output layer that includes a plurality of output nodes operably coupled to at least one of the plurality of hidden layers, each of the plurality of output nodes to provide a respective one of a plurality of output values, each of the plurality of output values at a respective one of the plurality of frequencies;
wherein the plurality hidden layers comprise a plurality of weight factor matrices;
wherein the plurality of weight factor matrices comprises a plurality of weight factor matrices generated by decomposition of an m×n weight factor matrix;
wherein decomposition of an m×n weight factor matrix comprises decomposing the m×n weight factor matrix into a product of three matrices UΣV, where;
U includes an m×m unitary matrix,
Σincludes an m×n rectangular diagonal matrix, and
V includes an n×n unitary matrix; and
wherein the decomposition of the m×m unitary matrix U and the n×n unitary matrix V comprises decomposition of the U and V matrices into a plurality of photonic beam splitters and a plurality of phase shifters using at least one of the Reck-Zeilinger method or the Clements method.

2. The neural network of claim 1 wherein each of the hidden layers includes a plurality of nodes, each of the nodes having the same weight factor for each of the plurality of frequencies.

3. The neural network of claim 1 wherein each of the hidden layers includes a plurality of nodes, each of the nodes having a different weight factor for each of at least two of the plurality of frequencies.

4. The neural network of claim 1 wherein each of the hidden layers performs at least one matrix multiplication and accumulation operation.

5. (canceled)

6. (canceled)

7. (canceled)

8. (canceled)

9. The neural network of claim 1 wherein one or more of the plurality of photonic beam splitters and one or more of the plurality of phase shifters are grouped into Mach Zehnder Interferometers (MZIs).

10. The neural network of claim 1 wherein each of the plurality of frequencies includes matched optical path lengths through the plurality of hidden layers.

11. The neural network of claim 1 wherein plurality of hidden layers comprise an m×n weight matrix.

12. The neural network of claim 11 further comprising one or more splitter elements to split each of a plurality of input signals equally into m paths upstream of the m×n weight matrix.

13. The neural network of claim 12 wherein the one or more splitter elements comprise at least one of: one or more 1-to-m multimode interferometers; one or more Y-junction arrays; or one or more directional couplers.

14. The neural network of claim 12 further comprising one or more accumulator elements to combine each of a plurality of output signals downstream of the m×n weight matrix.

15. The neural network of claim 14 wherein the one or more accumulator elements comprise at least one of: one or more m-to-1 multimode interferometers; one or more Y-junction arrays; or one or more directional couplers.
